(19) United States
(12) Patent Application Publication
(10) Pub. No.: US 2009/0209301 A1
(43) Pub. Date: Aug. 20, 2009

(54) ELECTRONIC DEVICE WITH DETACHABLE KEYPAD MODULE

(75) Inventors: Cheng-Yu LIN, Taipei (TW); Chi-Cheng Liao, Taipei (TW)

Correspondence Address: Muncy, Geissler, Olds & Lowe, PLLC, P.O. BOX 1364, FAIRFAX, VA, 22038-1364, US

(73) Assignee: ASUSTeK COMPUTER INC.

(21) Appl. No.: 12/353,690

(22) Filed: Jan. 14, 2009

(30) Foreign Application Priority Data
Feb. 14, 2008 (TW) 097105160

(51) Int. Cl. H04M 1/00

(52) U.S. Cl. 455/575.1

(57) ABSTRACT

The invention provides an electronic device with a detachable keypad module including a casing, a main circuit board and a detachable keypad module. The detachable keypad module is slidingly disposed at the casing and electrically connected to the main circuit board. The detachable keypad module includes a plurality of keys, a keypad circuit board and a keypad casing. The keypad circuit board is disposed between the keys and the main circuit board.

### CROSS REFERENCE TO RELATED APPLICATIONS

This Non-provisional application claims priority under 35 U.S.C. §119(a) on Patent Application No(s). 097105160 filed in Taiwan, Republic of China on Feb. 14, 2008, the entire contents of which are hereby incorporated by reference.

### BACKGROUND OF THE INVENTION

1. Field of Invention

The invention relates to an electronic device and, more particularly, to an electronic device with a keypad module.

2. Related Art

When a conventional electronic device is assembled, a keypad module is assembled to the electronic device in a locking mode or a fastening mode before a main circuit board is put into a casing. On the contrary, when the keypad module assembled at the casing needs to be detached, a user has to detach the main circuit board first to remove the keypad module from the casing.

For example, FIG. 1 is a partial exploded diagram showing the conventional electronic device. The electronic device is a smart phone. In the smart phone 1, fastening portions 122 of a casing 12 are fastened to a main circuit board 16 and a keypad module 14. To make the main circuit board 16 and the keypad module 14 firmly connected to the casing 12, the smart phone 1 further has a plurality of locking portions 121 and 161. Additional locking elements 18 (such as screws) lock the locking portions 121 and 161 to increase the structure strength of the main circuit board 16, the keypad module 14 and the casing 12. In addition, as far as the connection relationship of the keypad module 14 and the casing 12 is concerned, to increase the structure strength of the keypad module 14 and the casing 12 and to avoid making a user uncomfortable when he or she presses keys 141 which become loose, besides the locking portions 121, the keypad module 14 and the casing 12 also can be connected to each other by a plurality of fastening portions 123 (such as hooks). However, when the user wants to replace the keypad module 14 with different language versions or different size standards, the locking elements 18 used to lock the main circuit board 16, the casing 12 and the keypad module 14 should be loosen first. Then, the main circuit board 16 is taken out of the casing 12. At last, the keypad module 14 fastened to the casing 12 can be successfully detached.

In addition, apart from the inconvenience in the process of detaching the keypad module 14, since the keys 141, the keypad circuit board (not shown in FIG. 1) and the keypad casing 142 in the conventional keypad module 14 are connected with each other and assembled to be a single structure, any single component in the structure cannot be detached or replaced randomly according to the requirement of the user. For example, when the user wants to replace the keys 141 in the keypad module 14, he has to break the whole structure of the keypad module 14 to remove the keys 141. This not only consumes much time in detaching or attaching, but also may irreversibly damage the keypad module 14 during the operation process. Therefore, when the conventional keypad module 14 is assembled or replaced, the process is complicated, and unnecessarily consumed cost is large.

### SUMMARY OF THE INVENTION

The invention provides an electronic device with a detachable keypad module. The components of the keypad module can be replaced, respectively. Thus, the flow path of replacing the keypad module is simplified, the duplication cost is reduced and the convenience for a user increases.

The invention provides the electronic device with the detachable keypad module including a casing, a main circuit board and a detachable keypad module. The main circuit board is disposed at the casing, and the detachable keypad module is slidingly disposed at the casing and electrically connected to the main circuit board. The detachable keypad module includes a plurality of keys, a keypad circuit board and a keypad casing. The keypad circuit board is disposed between the keys and the main circuit board.

According to the electronic device with the detachable keypad module of the invention, the keypad module is connected to the casing of the electronic device in a sliding and fastening mode to allow the keypad module to be detached from the casing or reassembled easily. In addition, the keys, the keypad circuit board and the keypad casing in the keypad module are all independent elements, and therefore, any element or a plurality of elements may be replaced according to the requirement of the user. Compared with the conventional technology, when the keypad module of the electronic device with the detachable keypad module in the invention is detached or assembled, the detaching or assembling flow path is easy, and the duplication cost can be reduced. Moreover, the user can replace the keys, the keypad circuit board or the keypad casing in the keypad module according to the requirement. This increases the convenience of the electronic device.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a partial exploded diagram showing a conventional electronic device;

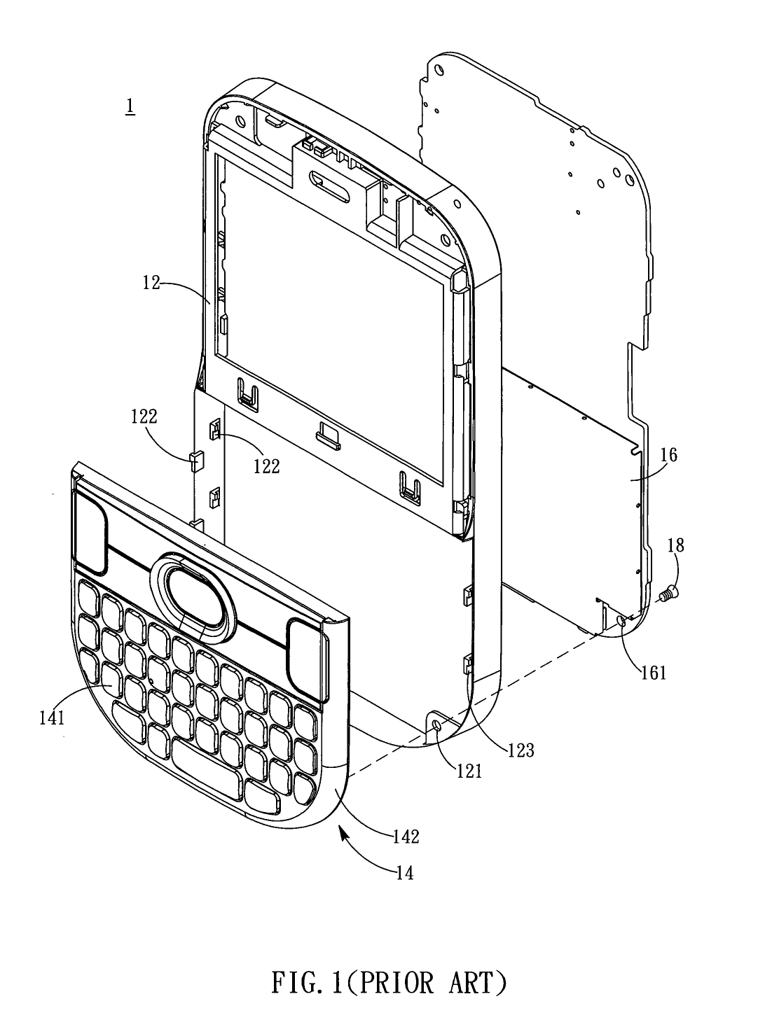

FIG. 2A is a partial exploded diagram showing an electronic device with a detachable keypad module in a preferable embodiment of the invention;

FIG. 2B is an exploded diagram showing the electronic device with a detachable keypad module in FIG. 2A from another angle;

FIG. 3A is a schematic diagram showing a partial exterior structure of the electronic device with the detachable keypad module in FIG. 2A;

FIG. 3B is a schematic diagram showing the structure of the A-A section in FIG. 3A; and

FIG. 4 is a partial exploded diagram showing another electronic device with a detachable keypad module in a preferable embodiment of the invention.

### DETAILED DESCRIPTION OF THE INVENTION

An electronic device with a detachable keypad module in an embodiment of the invention is described with related drawings hereinbelow. The same elements are denoted with the same reference characters.

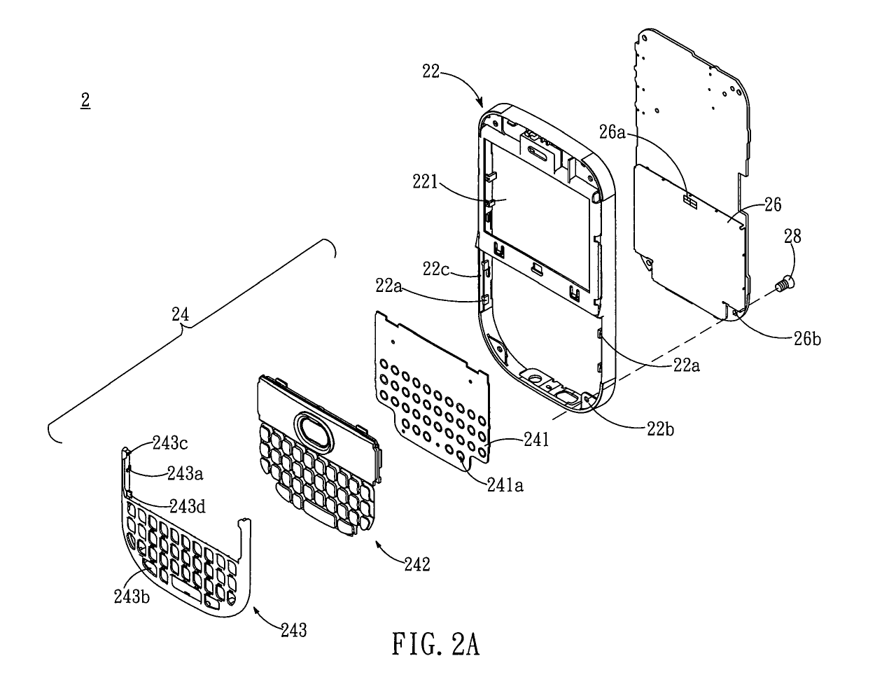

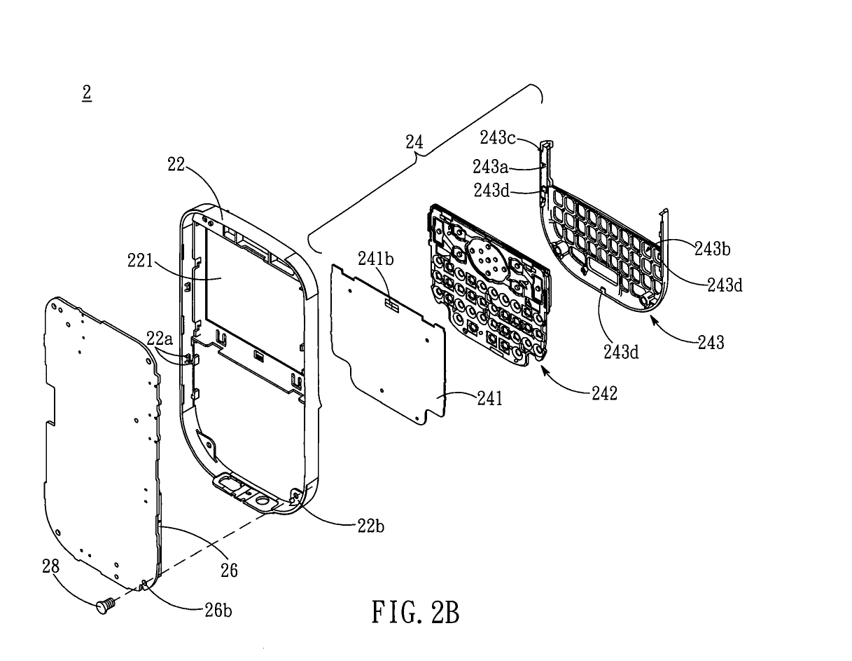

FIG. 2A and FIG. 2B are partial exploded diagrams showing an electronic device with a detachable keypad module in a preferable embodiment of the invention from different angles. As shown in FIG. 2A and FIG. 2B, the electronic device 2 with the detachable keypad module includes a casing 22, a detachable keypad module 24 and a main circuit board 26. The electronic device 2 with the detachable keypad module may be a computer, a smart phone, a personal digital assistant or an e-book reader, and the electronic device 2 here is a smart phone.

The casing 22 is a frame, and it may be made of metal, alloy, plastic steel, polymer or other materials. The casing 22 has an opening 221 for accommodating a display panel (not shown), and a plurality of fastening portions 22a and locking portions 22b may be disposed on the casing 22. The fastening portions 22a and locking portions 22b are used to connect the casing 22 to the detachable keypad module 24 and the main circuit board 26.

The detachable keypad module 24 is slidingly disposed at the casing 22 and includes a keypad circuit board 241, a plurality of keys 242 and a keypad casing 243. The keypad circuit board 241 is disposed between the keys 242 and the main circuit board 26. The composition of the keys 242 is a standard key set. A plurality of fastening portions 243a, a first sliding portion 243c and a plurality of fixing portions 243d are disposed on the keypad casing 243. The fastening portions 243a of the keypad casing 243 are corresponding to the fastening portions 22a of the casing 22. A second sliding portion 22c may be disposed at the casing 22 correspondingly to the detachable keypad module 24. The first sliding portion 243c cooperates with the second sliding portion 22c of the casing 22 to allow the detachable keypad module 24 to be slidingly disposed at the casing 22. Moreover, the keypad casing 243 has a plurality of openings 243b to allow the keys 242 to be exposed out of the keypad casing 243 through the openings 243b.

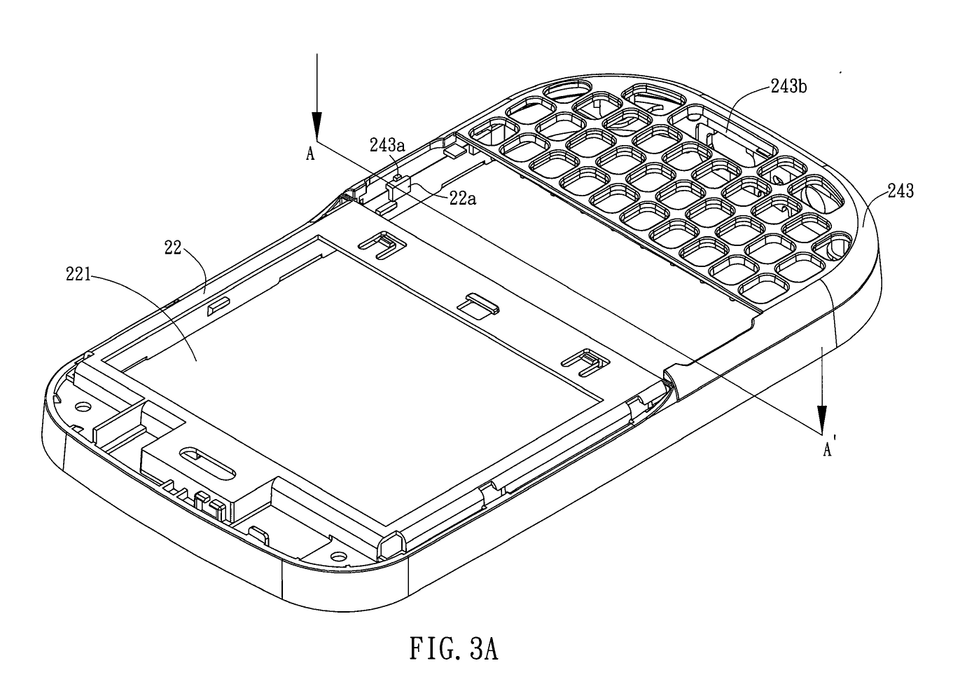

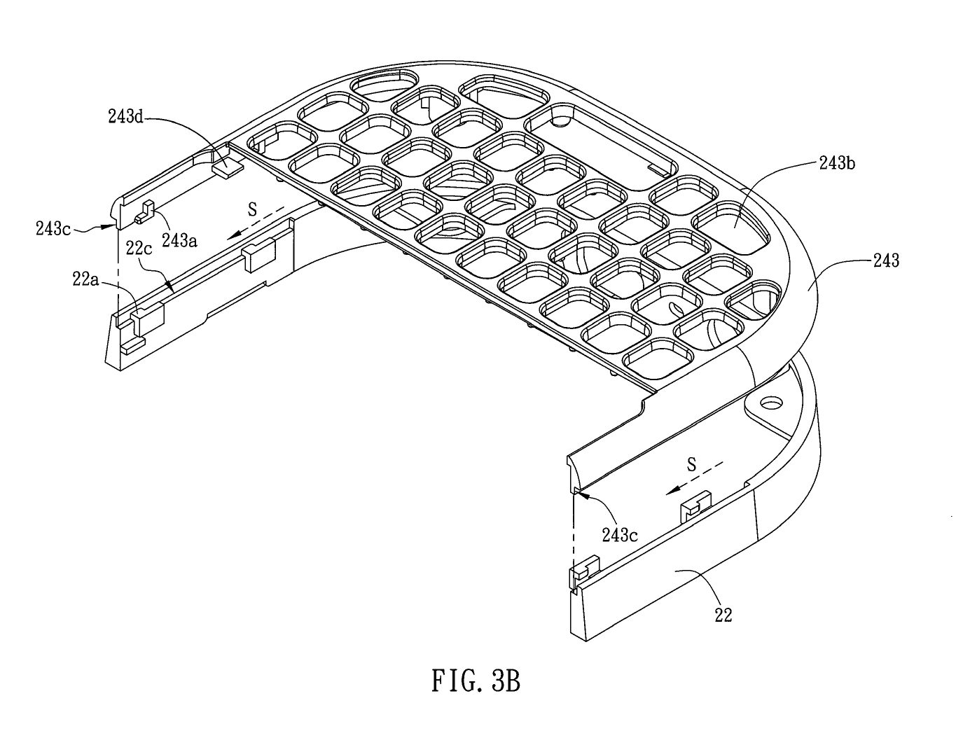

The structure of the detachable keypad module 24 slidingly disposed at the casing 22 is shown in FIG. 3A and FIG. 3B. FIG. 3A is a schematic diagrams showing a partial exterior structure of the electronic device with the detachable keypad module in FIG. 2A. FIG. 3B is a schematic diagram showing the structure of A-A section in FIG. 3A. As shown in FIG. 3A and FIG. 3B, when the first sliding portion 243c is disposed on the detachable keypad module 24, the second sliding portion 22c may be correspondingly disposed on the casing 22. Thus, the detachable keypad module 24 (the keypad casing 243 stands for it in the FIG. 3B) can easily slide at the casing 22 along the sliding direction S pointed by an arrow shown in FIG. 3B. Furthermore, although the first sliding portion 243c of the keypad module 24 in the embodiment is a slide block, and the second sliding portion 22c of the casing 22 is a runner. In actual application, the first sliding portion 243c and the second sliding portion 22c may be selected from slide rail, runner, slide block or other sliding structures, respectively, according to different designs. However, the structures of the first sliding portion 243c and the second sliding portion 22c should be the structures corresponding to each other so that they can slide relatively.

As shown in FIG. 2A and FIG. 2B, since the detachable keypad module 24 and the casing 22 may be fastened to each other by the corresponding fastening portions 243a and the fastening portions 22a, besides the sliding mode, the detachable keypad module 24 and the casing 22 may be assembled by the fastening portions 243a and 22a in a fastening mode. Thus, when a user wants to detach the detachable keypad module 24 from the casing 22, he or she only needs to slide the detachable keypad module 24 to make the fastening portions 243a on the detachable keypad module 24 and the fastening portions 22a on the casing 22 dislocated. Then, the detachable keypad module 24 can easily slide out of the casing 22, and it may be detached from the casing 22. On the contrary, when the user wants to assemble the detachable keypad module 24 at the casing 22, he or she can make the detachable keypad module 24 slide for a certain distance relative to the casing 22 to make the fastening portions 243a and the fastening portions 22a fastened to each other. Then, the objective to fix the detachable keypad module 24 to the casing 22 can be achieved.

As far as the fixing portions 243d on the keypad casing 243 of the keypad module 24 are concerned, FIG. 2B shows a preferred visual angle from which the fixing portions 243d is shown. In the embodiment, the keypad casing 243 has three fixing portions 243d, and they are at the left side, right side and lower side of the keypad casing 243, respectively. A space exists between each of the three fixing portions 243d and the keypad casing 243, so that the keypad circuit board 241 and a plurality of keys 242 included in the detachable keypad module 24 can be sandwiched between the fixing portions 243d and the keypad casing 243. That is, the keys 242 can be sandwiched between the keypad casing 243 and the keypad circuit board 241. Thus, the keys 242 can be exposed from the corresponding openings 243b of the keypad casing 243. When the user needs to replace the keypad circuit board 241 or keys 242 with different standards, he or she only needs to replace the old ones by a new keypad circuit board 241 or the keys 242 after detaching the detachable keypad module 24 from the casing 22 according to the above method and removing the keypad circuit board 241 fastened to the keypad casing 243.

Though the keypad casing 243 in the embodiment of the invention has three fixing portions 243d, and they are at the left side, the right side, and the lower side of the keypad casing 243, respectively, in actual application, the number and corresponding positions of the fixing portions 243d in the keypad casing 243 may be different according to different designs and standards of products, The illustration above is only one embodiment of the invention, which is not used to limit the scope of the invention.

The electrical connection portion 241b of the keypad circuit board 241 may be a golden finger. Thus, the keypad circuit board 241 can be electrically connected to the main circuit board 26. Moreover, a plurality of switch units 241a are disposed on a surface of the keypad circuit board 241, and the surface is corresponding to the keys 242. In the embodiment, the switch unit 241 is, for example, a metal dome. The main circuit board 26 is disposed in the casing 22. The main circuit board 26 includes an electrical connection portion 26a via which the main circuit board 26 disposed in the casing 22 may be electrically connected to the electrical connection portion 241b of the detachable keypad module 24. Therefore, the electrical connection portion 241b of the keypad circuit board 241 is electrically connected to the electrical connection portion 26a of the main circuit board 26. When the keys 242 are pressed, by triggering the switch units 241 a corresponding to the keys 242, the main circuit board 26 drives to start an signal input function corresponding to the keys 242.

As far as the connection relationships between the casing 22 is concerned, the detachable keypad module 24 and the main circuit board 26 is concerned, the main circuit board 26 can be fixed by the fastening portions 22a disposed in different positions of the casing 22, respectively. As far as the fixing relationship between the casing 22 and the main circuit board 26 is concerned, a locking element 28 (such as a screw) is used to lock the locking portion 26b on the main circuit board 26 to the locking portion 22b on the casing 22. The locking portion 26b and the locking portion 22b are set in the positions corresponding to each other. Thus, the locking element 28 is fixed to the locking portion 26b and the locking portion 22b.

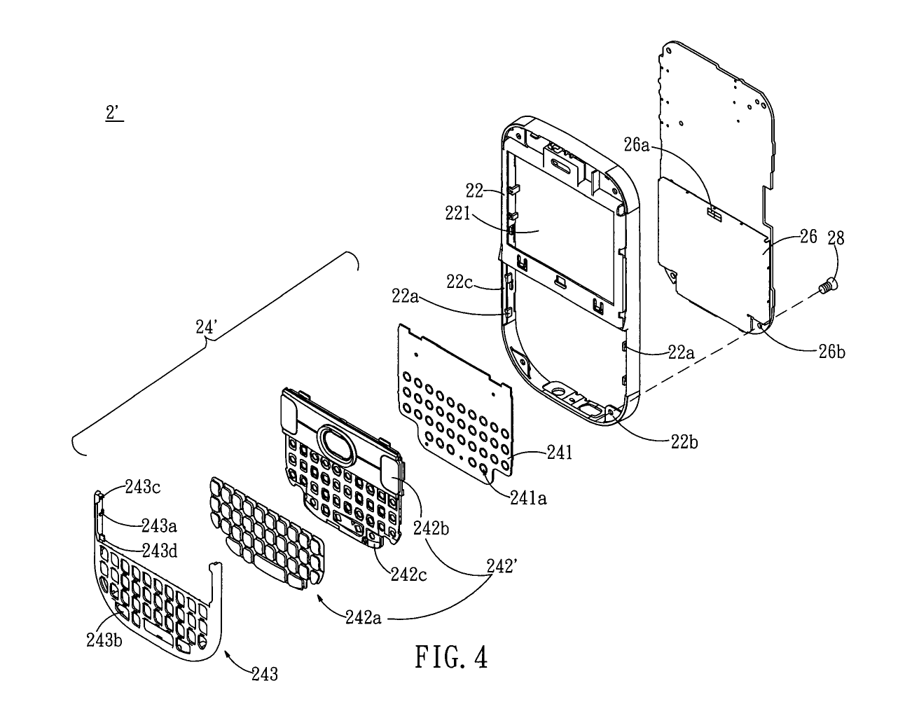

As shown in FIG. 4, it is a partial exploded diagram showing another electronic device with a detachable keypad module in a preferable embodiment of the invention. The electronic device 2′ with the detachable keypad module includes a casing 22, a detachable keypad module 24′ and a main circuit board 26. What is different from the embodiment above is that the detachable keypad module 24′ in the embodiment includes a keypad circuit board 241, a plurality of keys 242′ and a keypad casing 243. The composition of the keys 242′ further include a standard key set 242a and a functional key set 242b, and the functional key set 242b further includes a substrate 242c. The functional key set 242b is connected to the standard key set 242a via the substrate 242c. To allow the light generated from the light emitting element (not shown) on the keypad circuit board 241 to transmit to the standard key set 242a and the functional key set 242b via the substrate 242c, the substrate 242c is made of transparent material.

To sum up, the invention discloses an electronic device with a detachable keypad module. The keypad module is connected to the electronic device in a sliding and fastening mode to allow the keypad module to be detached or assembled easily without detaching the main circuit board. Moreover, the keys, keypad circuit board and the keypad casing in the keypad module are all independent elements, and therefore, at least one of the keys, the keypad circuit board and the keypad casing can be replaced according to the requirement of the user. When the electronic device with the detachable keyboard module in the invention is detached or assembled, the detaching or assembling flow path is simplified, and the duplication cost is reduced. Moreover, the user can replace the keys, the keypad circuit board or the keypad casing according to the requirement. This increases the convenience of the electronic device.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An electronic device with a detachable keypad module, comprising:
a casing;
a main circuit board disposed at the casing; and
a detachable keypad module slidingly disposed at the casing and electrically connected to the main circuit board, the detachable keypad module including a plurality of keys, a keypad circuit board and a keypad casing, wherein the keypad circuit board is disposed between the keys and the main circuit board.

2. The electronic device with the detachable keypad module according to claim 1, wherein the casing has a first sliding portion, and the keypad casing of the detachable keypad module has a second sliding portion to allow the detachable keypad module to be slidingly disposed at the casing.

3. The electronic device with the detachable keypad module according to claim 1, wherein the keypad casing comprises at least a fastening portion, and the keypad casing is fastened with the casing via the fastening portion.

4. The electronic device with the detachable keypad module according to claim 1, wherein the keypad casing further comprises a plurality of openings, and the keys are exposed through the openings.

5. The electronic device with the detachable keypad module according to claim 1, wherein the keypad casing further has at least a fixing portion, the keypad circuit board and the keys are fixed by the fixing portion, and the keys are sandwiched between the keypad circuit board and the keypad casing.

6. The electronic device with the detachable keypad module according to claim 1, wherein the composition of the keys is a standard key set.

7. The electronic device with the detachable keypad module according to claim 1, wherein the composition of the keys is a standard key set and a functional key set.

8. The electronic device with the detachable keypad module according to claim 7, wherein the functional key set further comprises a substrate, and the substrate is connected with the standard key set.

9. The electronic device with the detachable keypad module according to claim 8, wherein the substrate is transparent.

10. The electronic device with the detachable keypad module according to claim 1, wherein the keypad circuit board has a plurality of switch units, and the switch units are disposed to be corresponding to the keys.

11. The electronic device with the detachable keypad module according to claim 1, wherein at least an electrical connection portion is disposed at a surface of the keypad circuit board and a surface of the main circuit board corresponding to the surface of the keypad circuit board, respectively.
